(19) United States
(12) Patent Application Publication
(10) Pub. No.: US 2006/0028075 A1
(43) Pub. Date: Feb. 9, 2006

(54) Totally hermetically sealed motor for a vehicle

(76) Inventors: Shinichi Noda, Kanagawa-ken (JP); Yoshitaka Kobayashi, Saitama-ken (JP); Koji Okada, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/192,060

(22) Filed: Jul. 29, 2005

(30) Foreign Application Priority Data
Jul. 30, 2004 (JP) 2004-223968

(51) Int. Cl. H02K 9/00; H02K 3/24; H02K 5/00

(52) U.S. Cl. 310/64; 310/58; 310/89

(57) ABSTRACT

A stator frame (1) comprises: a housing (1m) whereof a modified tubular body mounted on the outer peripheral surface of a stator core (2) and that is virtually recessed at two locations in the direction of the rotary axis of a rotor; a cooling section (1n) that is integrally formed with one recess of this housing (1m) and wherein a passage (23) for the airflow generated by a circulating fan (11) is formed by forming a prescribed gap with respect to the outer peripheral surface of the stator core (2) and comprising heat-radiating fins (21); a foot (1o) that is integrally formed with another recess of this housing (1m) and wherein a passage (24) for the airflow generated by the circulating fan (11) is formed by forming a prescribed gap with respect to the outer peripheral surface of the stator core (2) and comprising heat-radiating fins (22); and a mounting section (1p).

### CROSS-REFERENCE TO RELATED APPLICATION

This application claims benefit of priority to Japanese application No. JP 2004-223968 filed 30th Jul., 2004, the entire contents of which are incorporated by reference herein.

### BACKGROUND OF THE INVENTION

1. Field of the Invention

The present invention relates to a totally hermetically sealed motor for a vehicle that drives for example a railway vehicle, having a totally hermetically sealed construction whereby the atmosphere is not admitted to the interior of the motor.

2. Description of the Related Art

In a railway vehicle such as a train, a motor for vehicle drive is mounted on a chassis that is arranged below the vehicle body and the vehicle is driven by transmitting the torque (turning force or turning effort) of this motor to the wheels through a gear mechanism.

Conventionally, motors of this type are of the open, self-ventilating cooling type, in which cooling is performed by passing external air into the motor by rotation of a ventilation fan that is fixed to the rotor shaft within the motor.

In such an open self-ventilating cooling type motor, a ventilation filter device is provided at the air inlet port in order to prevent the interior of the motor being contaminated by dust mixed with the cooling external air, the dust in the inflowing external air being captured by a filter in the ventilation filter device.

In order to prevent blockage of the filter from causing increased rise in temperature of the motor due to diminution of the inflow of external air, cleaning of the filter must therefore be performed at comparatively short intervals.

However, it is difficult for a filter to capture all the dust, so dust penetrating into the motor gradually adheres and accumulates in the interior of the motor, causing a lowering of installation performance and/or cooling effect. It is therefore necessary to periodically disassemble the motor in order to carry out cleaning to remove the dust in the interior.

The adoption of a motor for vehicle drive of a totally hermetically sealed type has been studied with a view to effecting savings in regard to maintenance of this filter and savings in regard to maintenance by extending the intervals of cleaning of the motor by disassembly.

An example of the construction of a prior art motor for vehicle drive of the totally hermetically sealed type is shown in FIG. 1 and FIG. 2. A ring-shaped (or annular) stator core 2 is arranged at the inner periphery of a tubular stator frame 1; a large number of coil slots, not shown, are provided at the inner periphery of this stator core 2, and stator coils 3 are accommodated within these slots. Bearing brackets 4, 5 respectively incorporating bearings 6, 7 are fitted in at both ends of the stator frame 1, so that both ends of the rotor shaft 8 are freely rotatably supported by means of these bearings 6 and 7. A rotor core 9 is mounted at the center of the rotor shaft 8, a large number of slots being formed in the outer periphery of the rotor core 9; rotor bars 10a are arranged at the center of these slots, both ends of the rotor bars 10a being integrally united by means of end rings (short-circuiting rings) 10b so as to thereby form as a whole a cage-shaped induction motor rotor (or squirrel-cage induction motor rotor).

A plurality of rotor ventilation holes 9a are provided on a circle at the inner periphery of the rotor core 9. A circulating fan 11 for circulating internal air is mounted in the interior of the motor on the rotor shaft 8.

Ventilation ports 1a, 1b are provided at both ends of the stator frame 1, coolers c of a construction described below being arranged so as to cover these ventilation ports 1a, 1b and mounted on the stator frame 1 by means of bolts, not shown.

In the coolers c, there are mounted connecting cooling air passages 12, 13 having internal spaces 12a, 13a; the coolers c are provided with pipes 14 so as to link the internal spaces 12a, 13a of the connecting cooling air passages 12, 13; and a large number of cooling fins 15 in the form of thin sheets of for example aluminum material are welded to the outer peripheral surface of the pipes 14.

In the motor construction described above, an arm 1c provided on the stator frame 1 is fixed to a chassis frame 16 by means of bolts and is connected with a gear mechanism (not shown) through a coupling at the end 8a of the rotor shaft that extends outside the motor and the gear mechanism is connected with a vehicle shaft 18 that is unitary with a vehicle wheel 17; in this way, the torque (turning force or turning effort) of the motor is transmitted to the vehicle wheel 17 that rolls along a rail 19.

Next, due to rotation of the circulating fan 11 during motor operation, the internal air within the motor enters the air inlet passage 12a of the cooler from the ventilation port 1a and furthermore flows through ventilation passages 14a, whence it enters an exhaust passage 13a and then flows into the interior of the motor from the ventilation port 1b. The internal air flowing into the interior of the motor returns in the radially inwards direction of the circulating fan 11 by flowing through ventilation holes 9a of the rotor core. In this way, the internal air is circulated within the coolers c and through the interior of the motor.

During motor operation, heat is generated by the stator coil 3 and rotor bars 10a and end ring 10b, thereby elevating the temperature of the various parts within the motor. However, the heated internal air is cooled by the cooling fins 15 when flowing through the ventilation passages 14a within the pipes 14. The internal air which is thus cooled is thereby able to cool all of the various parts within the motor by flowing through the interior of the motor and so can prevent the rise in temperature of the stator coil 3 and the rotor bars 10a exceeding the prescribed values.

The cooling effect of the internal air circulating through the ventilation passages 14a is increased by the fact that the cooling fins 15 are arranged orthogonal to the longitudinal direction of the motor in the same direction as the direction of movement of the vehicle, so the streamlines pass between the cooling fins 15, thereby improving the heat-radiating effect of the cooling fins 15.

Thus, with this construction, cooling of the motor is performed without passing external air into the motor, so the filter of the ventilation filter device becomes unnecessary and contamination of the interior of the motor is totally eliminated. The interval at which periodic disassembly of the motor must be performed can thereby be extended, resulting in laborsaving in regard to maintenance.

However, with a motor for vehicle drive of this totally hermetically sealed construction, there are the following three problems.

The first problem is that, since the cooling fins 15, constituting the coolers c, made of thin sheet such as for example aluminum material, must be joined by welding to the outer peripheral surface of the pipes 14, this large number of cooling fins 15 must be welded on one at a time: this adversely affects mass-production characteristics and involves a large number of manufacturing steps, resulting in increased costs.

The second problem is that a large number of ventilation passages 14a of the pipes 14 are arranged in a condition crowded together in the pipe structure and in addition the structure is partitioned by a large number of cooling fins 15, so dust or scraps of paper or fluff present in the atmosphere tend to adhere thereto, adversely affecting the cooling performance as dust gradually causes blockages between the pipes 14 with lapse of time of use. To avoid this it is therefore necessary to remove such dust or fluff by periodically blasting with compressed air. However, owing to the presence of the intersecting cooling fins 15, it is difficult to thoroughly remove dust etc that has become attached in cavities. For such reasons, in order to remove dust or fluff it is necessary to remove the main motor from the chassis, requiring a large-scale maintenance operation.

The third problem is that ventilation ports 1a, 1b are provided at both ends of the stator frame 1 and cooler comprising connecting cooling air passages and a plurality of pipes and a plurality of cooling fins 15 is mounted by means of bolts on the outer peripheral surface of the stator frame 1 so as to cover the ventilation ports 1a, 1b. In this case, there are slight gaps between the stator frame 1 and the coolers c, which therefore present contact heat resistance. Consequently, the rate of thermal conduction from the stator frame 1 to the coolers c is small. In other words, thermal conduction is poor. Consequently, the coolers c cannot be said to be effective.

### SUMMARY OF THE INVENTION

Accordingly, one object of the present invention is to provide a novel totally hermetically sealed motor for a vehicle that is suitable for mass production and wherein the number of manufacturing steps can be reduced, saving of maintenance and inspection time can be achieved, and wherein cooling performance is improved.

According to the present invention, the above object can be achieved by the following construction. Specifically, in a totally hermetically sealed motor for a vehicle comprising: a ring-shaped stator core; a modified tubular stator frame that is fixed to the outer peripheral surface of said stator core; and a rotor comprising a circulating fan that is freely rotatably supported by bearing brackets arranged at both ends of the stator frame on the inner peripheral side of the stator core and that circulates air within the motor body that is formed by the stator frame and the bearing brackets formed at the ends in the axial direction thereof; the stator frame comprises: a housing wherein a modified tubular body that is mounted on the outer peripheral surface of the stator core is virtually recessed at a single location in the direction of the rotary axis of the rotor; and a cooling section of increased heat-radiating area compared with the housing and formed with a passage for the airflow generated by the circulating fan, by forming a prescribed gap with respect to the outer peripheral surface of the stator core that is integrally formed with the recess of this housing.

In addition, according to the present invention, the above object can be achieved by the following construction.

Specifically, in a totally hermetically sealed motor for a vehicle, the stator frame comprises: a housing wherein a modified tubular body that is mounted on the outer peripheral surface of the stator core is virtually recessed at two locations in the direction of the rotary axis of the rotor; a cooling section of increased heat-radiating area compared with the housing and formed with a passage for the airflow generated by the circulating fan, by forming a prescribed gap with respect to the outer peripheral surface of the stator core that is integrally formed with the recess of this housing; and a foot for placing on the installation surface and of increased heat-radiating area compared with the housing and formed with a passage for the airflow generated by the circulating fan, by forming a prescribed gap with respect to the outer peripheral surface of the stator core that is integrally formed with the other recess of the housing.

In addition, according to the present invention, the above object can be achieved by the following construction. In a totally hermetically sealed motor for a vehicle comprising: a ring-shaped stator core; a modified tubular stator frame that is fixed to the outer peripheral surface of the stator core; and a rotor comprising a circulating fan that is freely rotatably supported by bearing brackets arranged at both ends of the stator frame on the inner peripheral side of the stator core and that circulates air within the motor body that is formed by the stator frame and the bearing brackets formed at the ends in the axial direction thereof; the stator frame comprises: a housing wherein the modified tubular body that is mounted on the outer peripheral surface of the stator core is recessed at a single location in the direction of the rotary axis of the rotor; and a cooling section wherein a passage for the airflow generated by the circulating fan is formed by forming a prescribed gap with respect to the outer peripheral surface of the stator core and comprising, in this airflow passage, a plurality of heat-radiating fins in the direction coinciding with the direction of the rotary axis of the rotor, and whose two respective ends are joined with a recess of this housing.

In addition, according to the present invention, the above object can be achieved by the following construction.

Specifically, in a totally hermetically sealed motor for a vehicle the stator frame comprises: a housing wherein a modified tubular body that is mounted on the outer peripheral surface of the stator core is recessed at two locations in the direction of the rotary axis of the rotor; a cooling section wherein a passage for the airflow generated by the circulating fan is formed by forming a prescribed gap with respect to the outer peripheral surface of the stator core and comprising, in this airflow passage, a plurality of heat-radiating fins for cooling in the direction coinciding with the direction of the rotary axis of the rotor, and whose two respective ends are joined with one recess of this housing; and a foot wherein a passage for the airflow generated by the circulating fan is formed by forming a prescribed gap with respect to the outer peripheral surface of the stator core and comprising, in this airflow passage, a plurality of heat-radiating fins for cooling in the direction coinciding with the direction of the rotary axis of the rotor, and whose two respective ends are joined with another recess of the housing.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein

FIG. 1 is an axial cross-sectional view sectioned in the axial direction showing only the upper half, the lower half being omitted, of a prior art totally hermetically sealed motor for a vehicle (cross-sectional view seen in the direction of the arrow, sectioned along the line A-A of FIG. 2);

FIG. 2 is a side view showing an end in the axial direction, in the totally hermetically sealed motor in the case where the lower half omitted in FIG. 1 is present;

FIG. 3A, FIG. 3B and FIG. 3C are views given in explanation of the chassis of a railway vehicle in which a motor according to the present invention is employed;

FIG. 4 is an axial cross-sectional view sectioned in the axial direction showing only the upper half, the lower half being omitted, of a totally hermetically sealed motor for a vehicle according to a first embodiment of the present invention;

FIG. 5 is a side view showing an end in the axial direction, in the totally hermetically sealed motor in the case where the lower half omitted in FIG. 4 is present;

FIG. 6 is a perspective view showing the stator frame of FIG. 4 and FIG. 5;

FIG. 7 is a graph given in explanation of the temperature lowering effect of the first embodiment of the present invention;

FIG. 8 is an axial cross-sectional view sectioned in the axial direction showing only the upper half, the lower half being omitted, of a totally hermetically sealed motor for a vehicle according to a second embodiment of the present invention;

FIG. 9 is a side view showing an end in the axial direction, in the totally hermetically sealed motor in the case where the lower half omitted in FIG. 8 is present;

FIG. 10 is an axial cross-sectional view sectioned in the axial direction showing only the upper half, the lower half being omitted, of a totally hermetically sealed motor for a vehicle according to a third embodiment of the present invention;

FIG. 11 is a side view showing an end in the axial direction, in the totally hermetically sealed motor in the case where the lower half omitted in FIG. 10 is present;

FIG. 12 is an axial cross-sectional view sectioned in the axial direction showing only the upper half, the lower half being omitted, of a totally hermetically sealed motor for a vehicle according to a fourth embodiment of the present invention;

FIG. 13 is a side view showing an end in the axial direction, in the totally hermetically sealed motor in the case where the lower half omitted in FIG. 12 is present;

FIG. 14 is an axial cross-sectional view sectioned in the axial direction showing only the upper half, the lower half being omitted, of a totally hermetically sealed motor for a vehicle according to a fifth embodiment of the present invention;

FIG. 15 is a side view showing an end in the axial direction, in the totally hermetically sealed motor in the case where the lower half omitted in FIG. 14 is present;

FIG. 16 is an axial cross-sectional view sectioned in the axial direction showing only the upper half, the lower half being omitted, of a totally hermetically sealed motor for a vehicle according to a sixth embodiment of the present invention; and

FIG. 17 is a side view showing an end in the axial direction, in the totally hermetically sealed motor in the case where the lower half omitted in FIG. 16 is present.

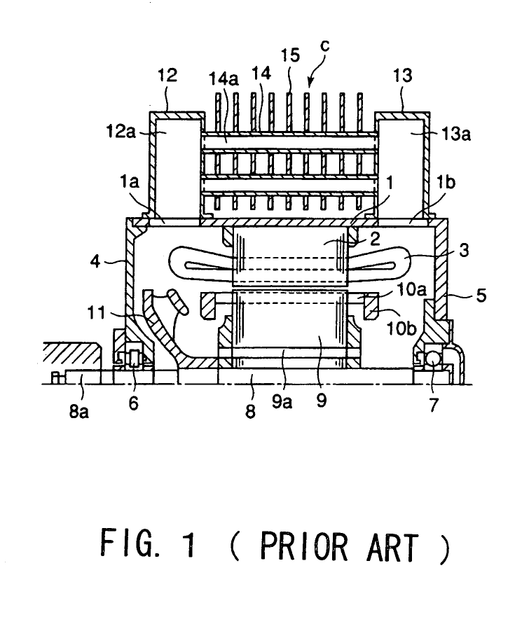

### DETAILED DESCRIPTION OF THE PREFERRED EMBODIMENTS

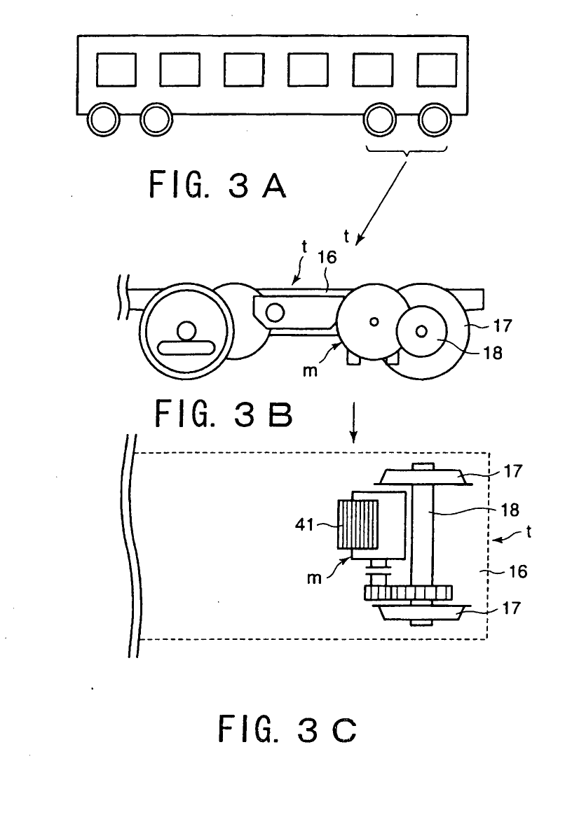

Referring now to the drawings, wherein like reference numerals designate identical or corresponding parts throughout the several views, and more particularly to FIGS. 3A, 3B, 3C, FIG. 4 and FIG. 5 thereof, one embodiment of the present invention will be described.

First of all, an application to which a totally hermetically sealed motor for a vehicle according to the present invention may be applied will be described. An electric motor m according to the present invention is removably mounted on a chassis frame 16 as shown in the side view to a larger scale of FIG. 3A in FIG. 3B (seen from the side with the portion of the chassis t to a larger scale) and in the undersurface view to a larger scale of FIG. 3A in FIG. 3C (seen from below with the portion of the chassis t to a larger scale) comprising a chassis t that is arranged fixed to the floor of a railway vehicle for example as shown in side view in FIG. 3A.

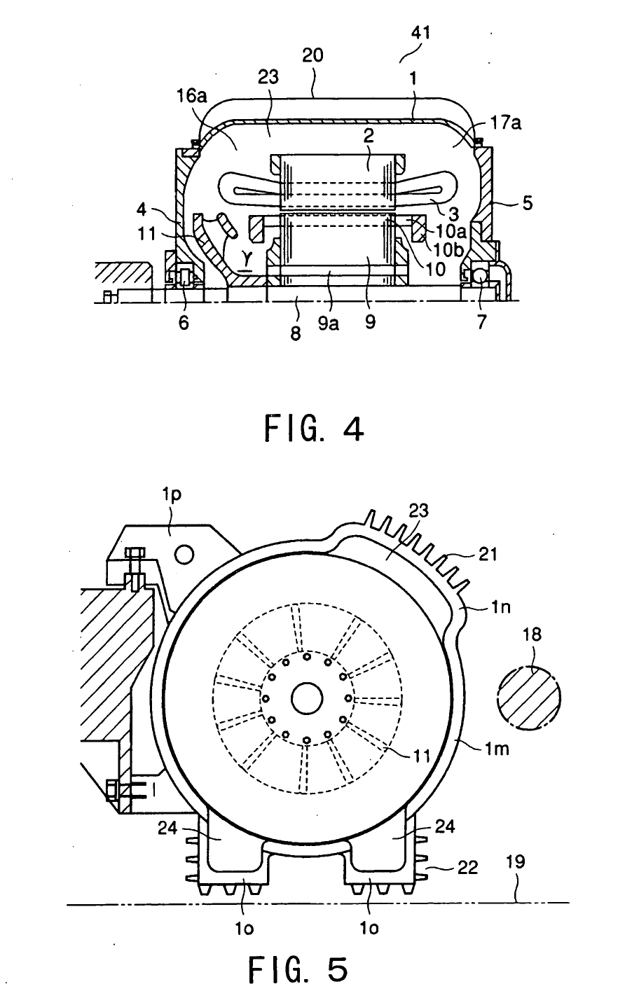

Thus, for example as shown in FIG. 4 and FIG. 5, a motor m comprises: a ring-shaped stator core 2; a modified tubular-shaped stator frame 1 fixed to the outer peripheral surface of the stator core 2; a circulating fan 11 whose rotary shaft 8 is freely rotatably supported by means of brackets 4, 5 accommodating bearings 6, 7 that are arranged at both ends of the stator frame 1 at the inner periphery of the stator core 2 and that circulates air through the motor body formed by the stator frame 1 and brackets 4, 5 formed in the vicinity of the ends in the axial direction of the rotor shaft 8; and a rotor r comprising a rotor core 9 integrally formed with the rotor shaft 8.

In a motor as proposed above, as will be described below, the housing and the cooling section are virtually integrally (or actually integrally) constructed with the stator frame 1.

This will be described below with reference to various embodiments, using the drawings.

### First Embodiment

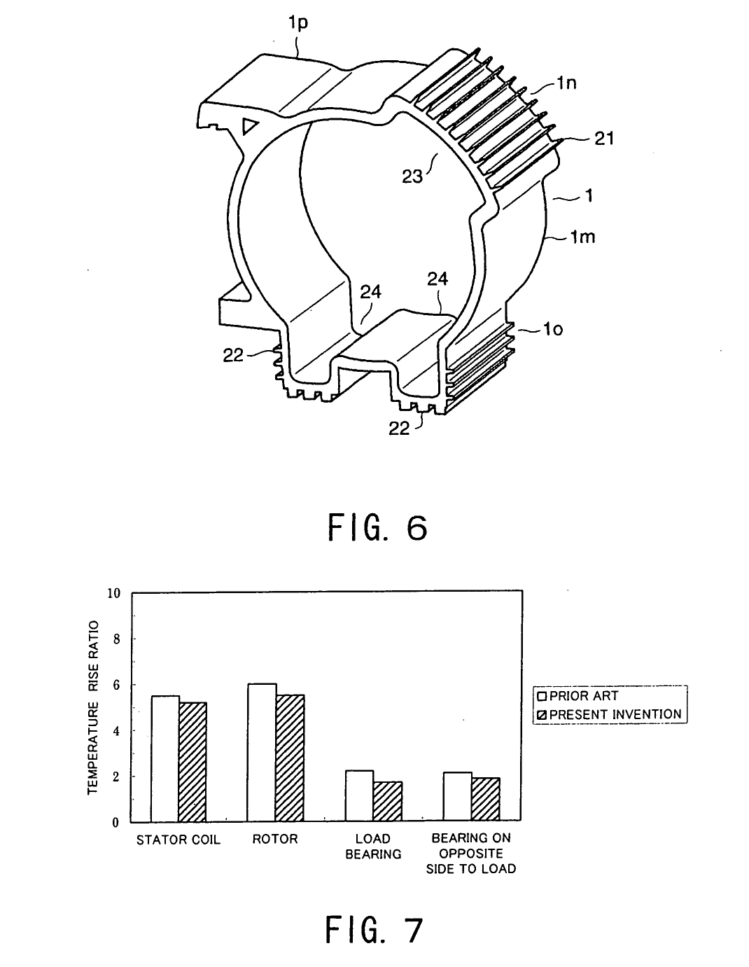

A totally hermetically sealed motor according to a first embodiment of the present invention is described with reference to FIG. 4, FIG. 5 and FIG. 6.

As shown in FIG. 6, the stator frame 1 comprises: a housing 1m whereof a modified tubular body that is mounted on the outer peripheral surface of the stator core 2 is virtually recessed in two locations in the direction of the rotary axis of the rotor; a cooling section in that is integrally formed at one of the recesses of this housing 1m, that is formed with a passage 23 for the airflow generated by the circulating fan 11 by formation of a prescribed gap with respect to the outer peripheral surface of the stator core 2 and that is of increased heat-radiating area compared with the housing 1m; two feet 1o of increased heat-radiating area compared with the housing 1m that are placed on the installation surface and that form passages 24 for the airflow generated by the circulating fan 11 by formation of a prescribed gap with respect to the outer peripheral surface of the stator core 2, being integrally formed with the other recess of the housing 1m; and a mounting section 1p.

In this regard, for the cooling section in, as an arrangement in which the heat-radiating area is increased compared with that of the housing 1m, a construction could be adopted in which for example a plurality of heat-radiating fins 21 are formed in the direction coinciding with the direction of the rotary axis of the rotor. Also, for the feet 1o, as an arrangement in which the heat-radiating area is increased compared with that of the housing 1m, a construction could be adopted in which for example a plurality of heat-radiating fins 22 are formed in the direction coinciding with the direction of the rotary axis of the rotor.

The stator frame 1 comprising the housing 1m, cooling section in, feet lo and mounting section 1p as described above is integrally formed by casting or extrusion.

The operation of a totally hermetically sealed motor for a vehicle according to this embodiment constructed as above is described below.

As shown in FIG. 3, during operation of the motor, the rotation of the circulating fan 11 feeds the air within the motor into the outer peripheral space in the radial direction of the circulating fan 11, after which this airflow flows in from the inlet section 1 of the passage 23 of the cooling section 1n and then, by circulating through the respective passages 23, flows into the space within the motor on the opposite side to the drive side.

The internal air flowing within the motor circulates through the ventilation holes 9a of the rotor core in the axial direction through the gap between the outer peripheral surface of the rotor core 9 and the inner peripheral surface of the stator core 2 and returns in the radially inwards direction of the circulating fan.

In this way, during operation, the air within the motor is circulated through the path constituted within the cooler. When the air within the motor circulates through the ventilation passages 23a, the passages 23 absorb heat and furthermore this heat is released to the atmosphere by the heat-radiating fins 20, of which a large number are provided.

With the embodiment described above, the following beneficial effects are obtained.

1) Since, rather than adopting a construction in which a plurality of cooling fins made of thin sheet such as aluminum material or the like are joined by welding to the outer peripheral surface of pipes, as in a prior art motor, a construction is adopted in which a large number of cooling fins 21 are integrally formed by casting or extrusion without needing to employ any form of welding, benefits are obtained in regard to mass-production, the number of manufacturing steps can be reduced, and manufacturing costs can be lowered.

2) Also, during operation, the circulating fan 11 circulates cooling internal air through the passage 23 of the cooling section in and the airflow passages 24 of the feet 1o. Also, the streamlines that are generated while the vehicle is moving flow between the outer peripheral surface of the stator frame 1 and the heat-radiating fins 21, 22, but, since the heat-radiating fins 21, 22 extend in the axial direction, even in the case of operation for a long period, dust or fluff etc cannot easily adhere to the cooling air passages, so the cooling effect of the heat-radiating fins 21, 22 shows no decrease even over many years.

3) Even if, over a long period of use, dust adheres to the surface, since the heat-radiating fins 21, 22 are mounted in the axial direction, this can more easily be removed by cleaning using for example air blasting than in the case of the prior art pipe construction, so the need for a large scale maintenance operation in which cleaning is performed by removing the main motor from the chassis disappears.

4) Since there is no contact thermal resistance between the stator frame 1 and the cooling section and the ventilation ports are provided at both ends of the stator frame 1 so that the ventilation ports are covered, regarding the stator frame 1 and the cooling section there is easy conduction to the cooler, thanks to thermal conduction of the temperature of the stator frame 1; thus an effective cooling section may be said to be provided.

Next, in order to ascertain the cooling effect of the present embodiment, a test of elevation of temperature was conducted using a test motor. In the test of temperature elevation, the test was conducted at the various rated speeds of operation of the motor, an inverter power source being used as the power source and simulating the effect of running of the vehicle using simulated streamlines (about 2 m/s) flowing around the main motor.

The results of the test are shown in FIG. 7. The scale of the vertical axis shows the ratio of temperature elevation and the horizontal axis shows the measurement points. From these results, it was found that although the overall cooling performance was slightly lower than that of the prior art product, fully satisfactory performance was obtained, within the rated values. This phenomenon was due to the fact that, in the present invention, cooling performance is improved due to improved heat conduction of the heat source constituted by the stator core 2 to the heat-radiating fins 21, 22. It may be said that cooling performance is improved due to the small airflow resistance presented to the circulation of air within the motor and thanks to the integral construction of the stator frame 1.

The prior art example described above and an embodiment of the present invention will now be compared.

Firstly, in the prior art pipe construction, the material used for the cooling passages is typically thin sheet steel, but, in order to reduce weight and improve cooling performance, aluminum sheet is sometimes used. However, in the prior art type construction welding of the aluminum sheet is difficult, so in cases where a large number of heat-radiating fins are provided, mass-production characteristics are adversely affected and manufacturing costs were therefore increased.

In contrast, in the case of the embodiment of the present invention, the stator frame 1 is integrally constructed of a housing 1m, cooling section 1n, feet lo and mounting section 1p, so manufacture can be achieved using for example casting or extrusion molding, so production costs can be greatly reduced.

Secondly, in the case of the prior art pipe construction, eddy currents are generated at the pipe inlets, so there was the big problem of inlet loss. However, with the embodiment of the present invention shown in FIG. 4 and FIG. 5, the air passage 23 is of tubular shape, so no eddy currents are generated and backflow does not occur.

Consequently, compared with the prior art pipe construction, inlet loss is small and, owing to the tubular shape, the airflow resistance of the passage 23 is small, so the rate of air circulation can be increased, thereby making it possible to improve the cooling performance of the main motor as a whole. Also, although during operation cooling air flows between the heat-radiating fins 20, due to their simple radial shape, even if, over a long period of operation, dust adheres to the surface, since the cooling fins are directed in the outwards direction of the wheels of the vehicle as shown in FIG. 4 and FIG. 5, this can more easily be removed by cleaning using for example air blasting than in the case of the prior art pipe construction, so the need for a large scale maintenance operation in which cleaning is performed by removing the main motor from the chassis disappears. That is, even if dust adheres to the overall surface of the heat-radiating fins 21, 22, since the heat-radiating fins 21, 22 are directed in the outwards direction of the wheels of the vehicle, this can easily be removed by cleaning using for example air blasting, so cleaning away of dust is straightforward and cleaning by removal of the main motor from the chassis becomes unnecessary so that maintenance does not become a large-scale time-consuming operation.

Also, by drawing the heat-radiating fins 21, 22 in the axial direction, these can be manufactured in a straightforward fashion in a single step even when they are of complex cross-sectional shape, by a processing method involving extrusion (drawing).

Thirdly, since there is no contact thermal resistance between the stator frame and the cooler, since there is not even a minute gap therebetween, the ventilation ports being provided at both ends of the stator frame 1 so that said ventilation ports are covered, regarding the stator frame and the cooler, there is easy conduction of the temperature of the frame to the cooler by thermal conduction; thus an effective cooling section may be said to be provided.

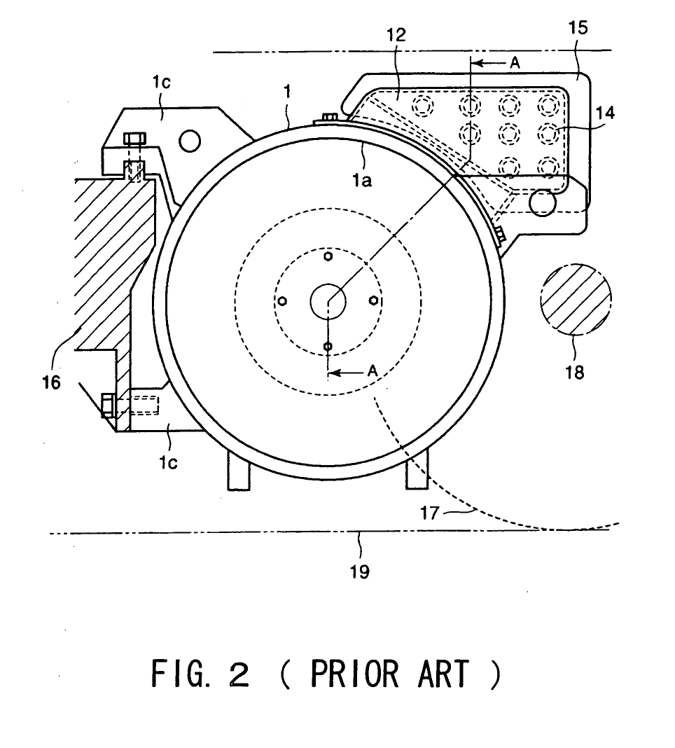

In FIG. 5, a cross-sectional view of the vehicle shaft 18 is depicted on the right-hand side laterally of the stator frame 1; this shows the positional relationship (positional relationship of the heights etc) of the vehicle shaft 18 of the vehicle and the motor that drives the vehicle wheel 17 (shown by a broken line in FIG. 2) and that is mounted on this vehicle.

Hereinbelow, when the vehicle shaft 18 is depicted, this configuration is shown.

### Second Embodiment

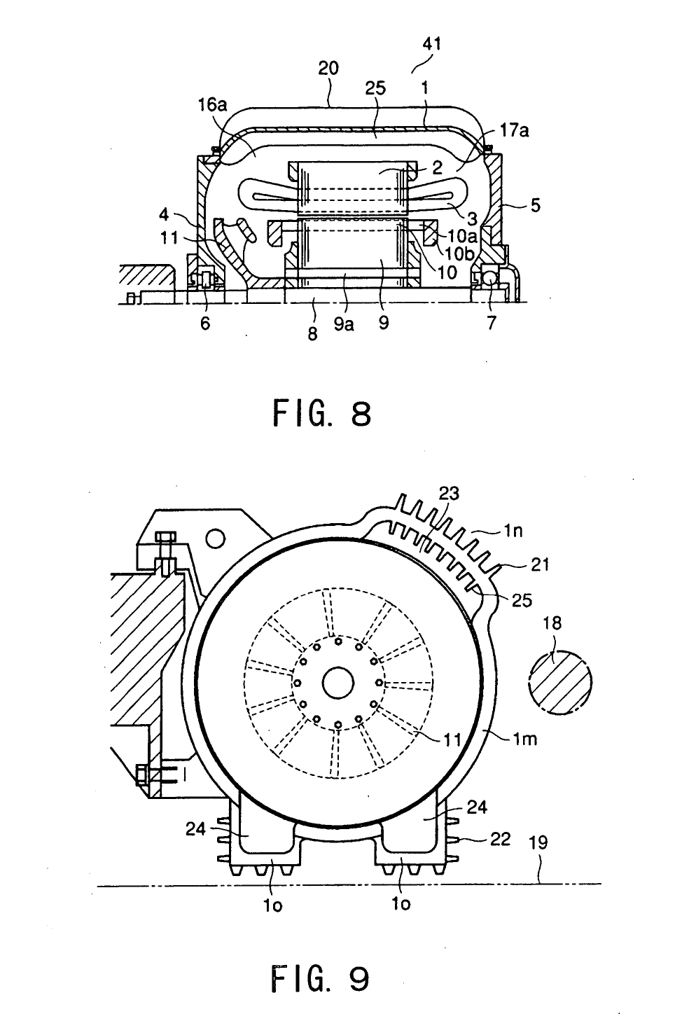

Next, the construction of a totally hermetically sealed motor for vehicle drive according to a second embodiment of the present invention is described with reference to FIG. 8 and FIG. 9.

In this embodiment, a plurality of heat-absorbing fins 25 are formed along the axial direction of the rotor in positions on the opposite side to the heat-radiating fins 21 within the airflow passage 23 in the interior of the cooling section 1n of the stator frame 1, seen from the axial direction of the motor. Other details are the same as in the case of the first embodiment.

In this case, since the plurality of heat-absorbing fins 25 extend in the axial direction in opposing positions (i.e. positions opposite the heat-radiating fins 21 on the opposite side thereto about the housing 1m as center) cooling performance is improved, due to conduction of heat to the heat-radiating fins 21 by the shortest distance. Further improvement in the cooling performance of the motor can be achieved, since heat can be emitted efficiently to the atmosphere.

### Third Embodiment

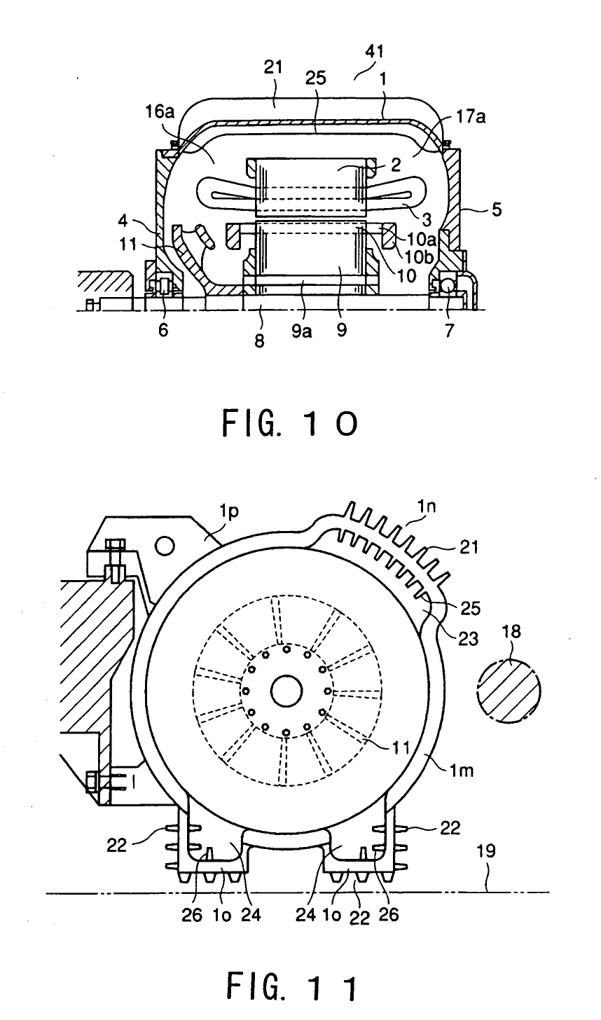

Next, a totally hermetically sealed motor for vehicle drive according to a third embodiment of the present invention is described with reference to FIG. 10 and FIG. 11. In this embodiment, a plurality of heat-absorbing fins 25 are formed along the axial direction of the rotor in a position opposite the heat-radiating fins 21 within the airflow passage 23 in the interior of the cooling section in of the stator frame 1, seen from the axial direction of the motor and, in addition, a plurality of heat-absorbing fins 26 are formed along the axial direction of the rotor in a position opposite the respective heat-radiating fins 22 within the airflow passage 24 in the interior of the two feet 1o of the stator frame 1, seen from the axial direction of the motor. Other details are the same as in the case of the first embodiment.

In this case, since the plurality of heat-absorbing fins 26 extend in the axial direction of the rotor in the same way as the heat-radiating fins 22, cooling performance is improved, due to conduction of heat to the heat-radiating fins 22 by the shortest distance. Further improvement in the cooling performance of the motor can be achieved, since heat can be emitted efficiently to the atmosphere. In this construction, the airflow passages 23, 24 are arranged at three locations in the circumferential direction as seen from the axial direction of the motor.

### Fourth Embodiment

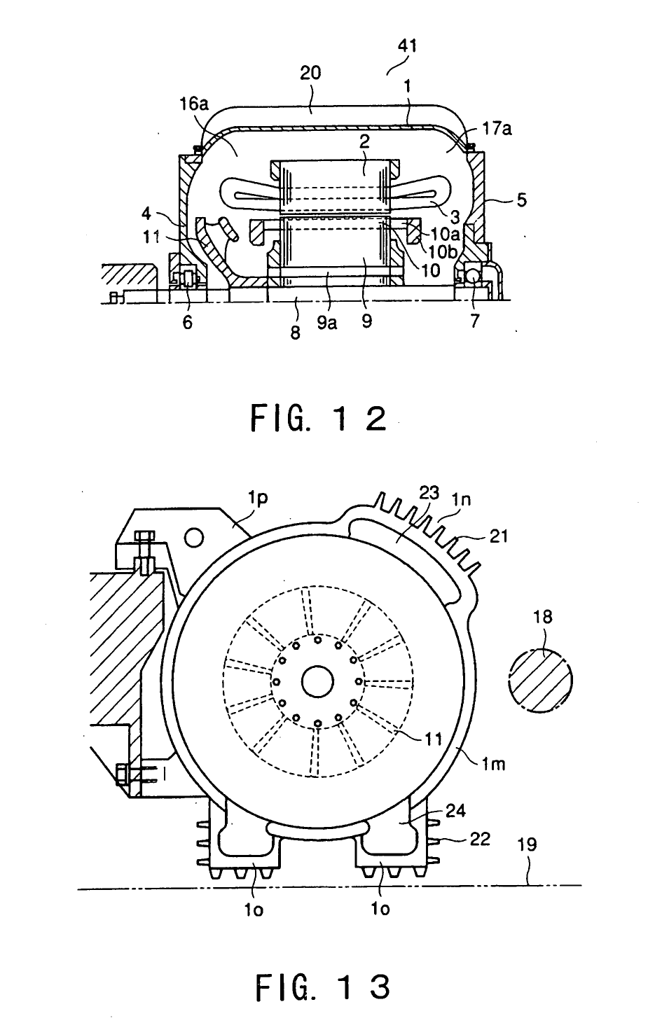

Next, the construction of a totally hermetically sealed motor for vehicle drive according to a fourth embodiment of the present invention is described with reference to FIG. 12 and FIG. 13. In this embodiment, the cross-sectional shape of the airflow passages 23, 24 of the cooling section in and/or feet 1o of the stator frame 1, and the shape of the streamlines towards the ventilation direction, for example the cross-sectional shapes of the passages, are formed in substantially rounded shape.

By means of such a construction, the channel resistance of the passage can be reduced and cooling performance improved.

### Fifth Embodiment

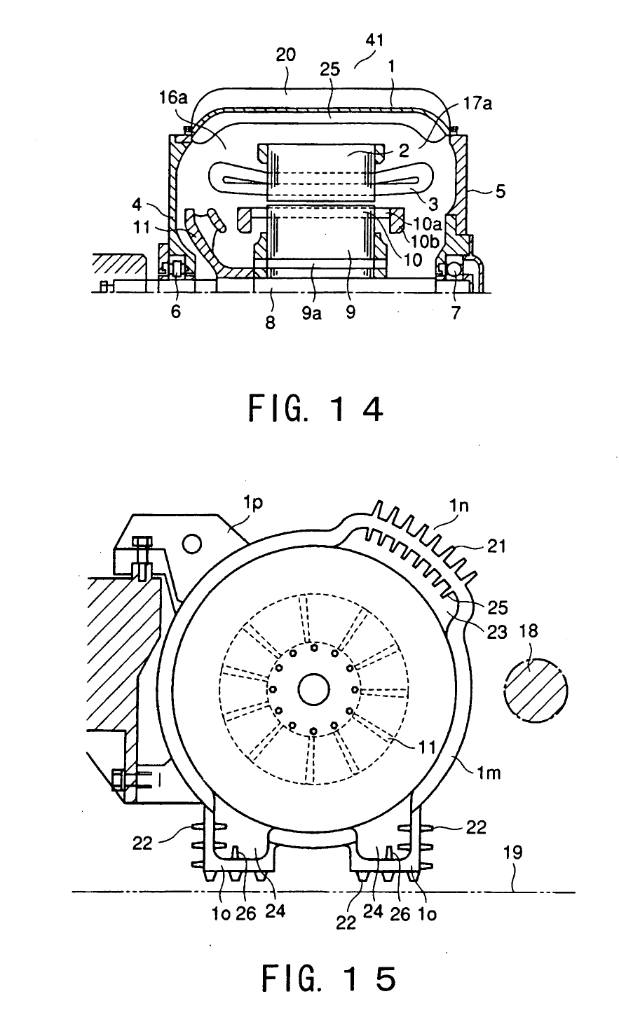

Next, a totally hermetically sealed motor for vehicle drive according to a fifth embodiment of the present invention is described with reference to FIG. 14 and FIG. 15. In this embodiment, the relationship between the circulating fan 11 and the brackets 4 and 5 is as follows. Specifically, in the case of a circulating fan 11 of excellent fan performance, the cross-sectional shape of the inside surface of the brackets 4, 5 on the side facing the motor is constructed so as to approximate to the radius of this circulating fan 11; also, the cross-sectional shape of the inside surface of the stator frame 1 on the side facing the motor is constructed so as to approximate to the radius of the circulating fan 11, the stator frame being joined to the brackets 4, 5. By means of such a construction, the channel resistance of the passage within the motor can be reduced and cooling performance improved.

### Sixth Embodiment

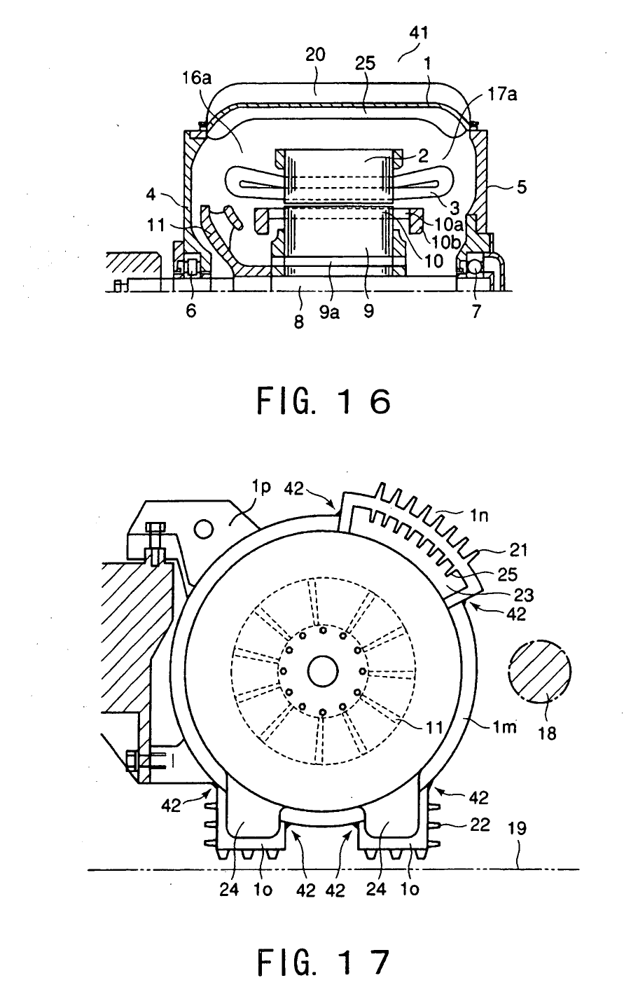

Next, a totally hermetically sealed motor for vehicle drive according to a sixth embodiment of the present invention is described with reference to FIG. 16 and FIG. 17. This embodiment is an example in which, instead of forming all of the housing 1m, cooling section in, feet 1o and mounting section 1p in unitary fashion as in the case of the stator frame 1 of FIG. 6 described above, a housing 1m, a cooling section in having heat-radiating fins 21 and/or heat-absorbing fins 25, feet 1o and a mounting section 1p having heat-radiating fins 22 and/or heat-absorbing fins 26 are separately formed, these being joined by for example welding 42 or the like to finally produce a construction as in FIG. 6.

In this way, although there is some loss of the benefits of the embodiments described above, mass-production characteristics are better than in the prior art example and manufacturing costs can be lowered.

### MODIFIED EXAMPLE

Although the embodiments described above were described taking as an example the application of the present invention to a railway vehicle, the invention could of course be applied to an automobile or to any independently mobile device.

Although in the embodiments described above, the case was described in which, in a motor body comprising a stator frame and bearing brackets, the stator frame was virtually or actually recessed in a direction coinciding with the direction of the rotary axis of the rotor, this could be implemented in the same way even if the stator frame were to be virtually or actually recessed in a direction coinciding with a direction orthogonal to the rotary axis of the rotor. Although, in the above embodiments, examples were described in which the stator frame 1 including the cooling section in and feet 1o was formed with three airflow passages 23, 24, depending on the application, four or more of these, or two, could be employed. Employing a minimum of three passages, as in the embodiments described above, has the merit that temperature uniformity of cooling is improved and satisfaction of space requirements can be guaranteed.

With the present invention, a totally hermetically sealed motor for a vehicle can be provided of improved cooling performance, that is suitable for mass production, wherein the number of manufacturing steps can be reduced, and whereby laborsaving in regard to maintenance and inspection can be achieved.

What is claimed is:

1. A totally hermetically sealed motor for a vehicle comprising:
a ring-shaped stator core;
a modified tubular stator frame that is fixed to an outer peripheral surface of said stator core; and
a rotor having a circulating fan-that is freely rotatably supported by bearing brackets arranged at both ends of said stator frame on an inner peripheral side of said stator core and that circulates air within a motor body that is formed by said stator frame and said bearing brackets formed at an end in an axial direction thereof;
wherein said stator frame comprises:
a housing wherein a modified tubular body that is mounted on said outer peripheral surface of said stator core is virtually recessed at a single location in a direction of a rotary axis of said rotor; and
a cooling section of increased heat-radiating area compared with said housing and formed with a passage for an airflow generated by said circulating fan, by forming a prescribed gap with respect to said outer peripheral surface of said stator core that is integrally formed with a recess of said housing.

2. A totally hermetically sealed motor for a vehicle comprising:
a ring-shaped stator core;
a modified tubular stator frame that is fixed to an outer peripheral surface of said stator core; and
a rotor having a circulating fan that is freely rotatably supported by bearing brackets arranged at both ends of said stator frame on an inner peripheral side of said stator core and that circulates air within a motor body that is formed by said stator frame and said bearing brackets formed at an end in an axial direction thereof;
wherein said stator frame comprises:
a housing wherein a modified tubular body that is mounted on said outer peripheral surface of said stator core is virtually recessed at two locations in a direction of a rotary axis of said rotor;
a cooling section of increased heat-radiating area compared with said housing and formed with a passage for an airflow generated by said circulating fan, by forming a prescribed gap with respect to said outer peripheral surface of said stator core that is integrally formed with one of recess of said housing; and
a foot for placing on an installation surface and of increased heat-radiating area compared with said housing and formed with a passage for an airflow generated by said circulating fan, by forming a prescribed gap with respect to said outer peripheral surface of said stator core that is integrally formed with another recess of said housing.

3. The totally hermetically sealed motor for a vehicle according to claim 1 or 2, further comprising a chassis mounting section integrally formed at said outer peripheral side of said housing of said stator frame.

4. The totally hermetically sealed motor for a vehicle according to claim 1 or 2, further comprising a plurality of heat-radiating fins on said outer peripheral surface in a direction that coincides with a direction of a rotary axis of said rotor, in an airflow passage of said cooling section of said stator frame.

5. The totally hermetically sealed motor for a vehicle according to claim 1 or 2, further comprising a plurality of heat-absorbing fins within an inner peripheral surface in a direction that coincides with a direction of a rotary axis of said rotor, in an airflow passage of said cooling section of said stator frame.

6. The totally hermetically sealed motor for a vehicle according to claim 1 or 2, further comprising a plurality of heat-radiating fins on said outer peripheral surface in a direction that coincides with a direction of a rotary axis of said rotor, in an airflow passage of said foot of said stator frame.

7. The totally hermetically sealed motor for a vehicle according to claim 1 or 2, further comprising
a plurality of heat-absorbing fins within an inner peripheral surface in a direction that coincides with a direction of a rotary axis of said rotor, in an airflow passage of said foot of said stator frame.

8. The totally hermetically sealed motor for a vehicle according to claim 1 or 2,
wherein said stator frame is formed by casting or extrusion.

9. A totally hermetically sealed motor for a vehicle comprising:
a ring-shaped stator core;
a modified tubular stator frame that is fixed to an outer peripheral surface of said stator core; and
a rotor having a circulating fan that is freely rotatably supported by bearing brackets arranged at both ends of said stator frame on an inner peripheral side of said stator core and that circulates air within a motor body that is formed by said stator frame and said bearing brackets formed at an ends in an axial direction thereof;
wherein said stator frame comprises:
a housing wherein a modified tubular body that is mounted on said outer peripheral surface of said stator core is recessed at a single location in a direction of a rotary axis of said rotor; and
a cooling section wherein a passage for an airflow generated by said circulating fan is formed by forming a prescribed gap with respect to said outer peripheral surface of said stator core and said cooling section having, in an airflow passage, a plurality of heat-radiating fins in a direction coinciding with a direction of a rotary axis of said rotor, and whose two respective ends are joined with a recess of said housing.

10. A totally hermetically sealed motor for a vehicle comprising:
a ring-shaped stator core;
a modified tubular stator frame that is fixed to an outer peripheral surface of said stator core; and
a rotor having a circulating fan that is freely rotatably supported by bearing brackets arranged at both ends of said stator frame on an inner peripheral side of said stator core and that circulates air within a motor body that is formed by said stator frame and said bearing brackets formed at an end in an axial direction thereof; wherein said stator frame comprises:
a housing wherein a modified tubular body that is mounted on said outer peripheral surface of said stator core is recessed at two locations in a direction of a rotary axis of said rotor;
a cooling section wherein a passage for an airflow generated by said circulating fan is formed by forming a prescribed gap with respect to said outer peripheral surface of said stator core and said cooling section having, in an airflow passage, a plurality of heat-radiating fins in a direction coinciding with a direction of a rotary axis of said rotor, and whose two respective ends are joined with one recess of said housing; and
a foot wherein a passage for an airflow generated by said circulating fan is formed by forming a prescribed gap with respect to said outer peripheral surface of said stator core and said foot having, in an air flow passage, a plurality of heat-radiating fins for cooling in a direction coinciding with a direction of a rotary axis of said rotor, and whose two respective ends are joined with another recess of said housing.

11. The totally hermetically sealed motor for a vehicle according to claim 9 or 10, further comprising
a chassis mounting section integrally formed at said outer peripheral side of said housing of said stator frame.

12. The totally hermetically sealed motor for a vehicle according to claim 9 or 10, further comprising a plurality of heat-absorbing fins in a direction coinciding with a direction of a rotary axis of said rotor in an airflow passage of said cooling section and/or foot of said stator frame.

13. The totally hermetically sealed motor for a vehicle according to any of claim 1, 2, 9 or 10,
wherein a cross-sectional shape of said airflow passage of said cooling section and/or foot of said stator frame is a streamline shape in a direction of a passage.

14. The totally hermetically sealed motor for a vehicle according to any of claim 1, 2, 9 or 10,
wherein said circulating fan is of a radius providing excellent fan performance and a cross-sectional shape of said internal surface, on a side facing a motor interior, of said bearing brackets approximates to a radius of said circulating fan, while said stator frame is joined with said bearing brackets and said cross-sectional shape of said internal surface, on a side facing a motor interior, of said stator frame approximates to a radius of said circulating fan of excellent fan performance.
